(19) United States
(12) Patent Application Publication
(10) Pub. No.: US 2006/0074004 A1
(43) Pub. Date: Apr. 6, 2006

(54) Light duty liquid detergent composition

(76) Inventors: Andress Kirsty Johnson, Pleasantville, NY (US); Maurice Dery, Putnam Valley, NY (US); Meiylin Fong Antezzo, Carmel, NY (US)

Correspondence Address: MICHELLE J. BURKE;AKZO NOBEL INC., 7 LIVINGSTONE AVENUE, DOBBS FERRY, NY, 10522-3408, US

(21) Appl. No.: 10/957,759

(22) Filed: Oct. 4, 2004

(51) Int. Cl. C11D 3/37

(52) U.S. Cl. 510/499

(57) ABSTRACT

A light duty liquid detergent composition having improved greasy and baked-on soil removal properties is disclosed which comprises at least one of certain described fatty amine derivatives and an anionic surfactant formulation comprising an alkylbenzene sulfonate having a C6-C22 alkyl group. Methods for making and using a light duty liquid detergent composition are also disclosed.

### FIELD OF THE INVENTION

The invention relates to light duty liquid detergent compositions, a method of making light duty liquid detergent composition, as well as methods for using such compositions.

### BACKGROUND OF THE INVENTION

Despite the popularity and convenience of automatic dishwashing machines, hand dishwashing remains a common activity among a large number of consumers. Light duty liquid detergents (also referred to as “LDLD” or “LDL”) are typically utilized for hand dish washing of kitchen utensils, plates, dishes, flatware, pots/pans, and other soiled food preparation items. Light duty liquid detergents are also commonly used to clean delicate textiles by hand as well as in the cleaning of automobile exteriors and many household hard surfaces, such as floors, painted woodwork, washable wallpaper and counter tops.

In general, it is desirable for LDL compositions to exhibit not only grease removal properties, but also high foaming characteristics, as consumers generally incorrectly associate the latter with the cleaning performance of the LDL. Also, as LDL compositions will usually come into contact not only with the surface to be cleaned, but also with the skin of the person who is cleaning, it is also desirable for the LDL to be mild and non-drying to human skin.

LDL compositions typically comprise a mixture of liquid surfactants. Many commercially available LDL compositions include one or more anionic surfactants that function as the primary cleaning component (or base surfactant formulation) within the LDL composition. In particular, alkylbenzene sulfonic acid is used extensively as it is an effective degreaser, has a good foam profile (except in hard water), is pH tolerant, and is low cost. Amines have been commonly used in LDL compositions as a source of alkalinity. Many LDL compositions further include divalent ions, such as Mg and Ca, to insure adequate cleaning of greasy soils in soft water. However, the use of such ions can have an undesirable effect on the stability of the LDL and may lead to the undesirable precipitation of such ions from the LDL.

U.S. Pat. No. 4,992,212 teaches the use of an organic base, a zinc salt and a complexing agent in a LDL composition to allow for the pretreatment of aluminum utensils with little or no associated staining of such utensils.

U.S. Pat. No. 5,981,466 describes a detergent composition, primarily for use in fabric laundering, which comprises alkyl alkoxylated sulfates and/or alkyl sulfates and specific primary and/or tertiary amines. However, there are limitations to the effectiveness of this formulation when as a LDL because of antagonist effects caused by the ether sulfates.

U.S. Pat. No. 5,990,065 also describes a hand dishwashing detergent comprising low molecular weight diamines. However, this invention requires the addition of magnesium and/or calcium, which results in less stable formulations. U.S. Pat. No. 6,069,122 also describes a hand dishwashing detergent comprising low molecular weight diamines.

However, none of the above patents disclose a LDL composition comprising one or more fatty amine derivatives selected from the group described herein and about 5% to about 50%, by weight, of an anionic base surfactant formulation, wherein the anionic base surfactant formulation comprises an alkylbenzene sulfonate having a C₆-C₂₂ alkyl group. Further, many of the prior art LDL compositions discussed above have a pH of 9 to 11, and sometimes higher, a range that may be irritating to human skin.

Thus, there remains a need for a cost effective LDL composition that can provide for the improved removal of baked-on greasy and fatty soils. A further need exits for a LDL composition effective for baked-on greasy and fatty soils which still maintains good foaming properties and which is in a pH range that is mild to human skin.

### SUMMARY OF THE INVENTION

It has now been unexpectedly found that the use of certain fatty amine derivatives in conjunction with certain anionic base surfactant formulations, as described in more detail herein, leads to improved cleaning properties when compared to prior art LDL compositions, while still maintaining desirable foaming, viscosity or mildness properties.

Due to the improved cleaning abilities of the present invention, it is also possible to reduce the total surfactant content in the LDL composition described herein while still maintaining the same level of cleaning as prior art LDL compositions, resulting in significant manufacturing cost savings.

Further, the strong cleaning properties of the present LDL composition allows for the reduction or elimination of Mg/Ca ions without a detrimental effect on cleaning ability.

More particularly, the present invention relates to a light duty liquid detergent composition comprising
(a) from about 5% to about 50%, by weight, of an anionic base surfactant formulation, wherein the anionic base surfactant formulation comprises an alkylbenzene sulfonate having a C₆-C₂₂ alkyl group; and
(b) at least one fatty amine derivative selected from the group consisting of: 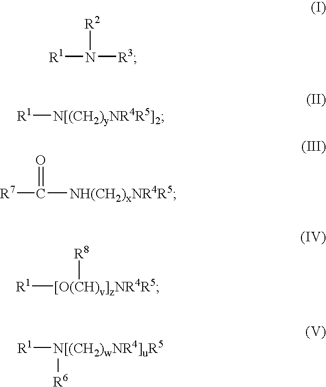
and mixtures thereof;
wherein R¹ is a C₆-C₂₂, linear or branched, saturated or unsaturated alkyl; R², R³, R⁴, R⁵, and R⁶ are each either hydrogen, methyl, hydroxethyl, hydroxypropyl, or an alkyl; or R² and R³, or R⁴ and R⁵ form a heterocyclic ring of up to 6 members with the nitrogen; or R² and R³, or R⁴ and R⁵ together form the group —CH₂CH₂OCH₂CH₂—; R⁷ is a C₅-C₂₁, linear or branched, saturated or unsaturated alkyl; R⁸ is hydrogen or methyl; w, x, and y are each an integer from 2 to 6; z is an integer from 1 to 30; u is an integer greater than or equal to 1; and v is an integer greater than or equal to 2.

In another aspect, the present invention relates to a method of making a light duty liquid detergent composition which comprises the steps of:
(a) adding at least one neutralization agent to water to form a solution;
(b) adding an alkylbenzene sulfonic acid having a C₆-C₂₂ alkyl group to the solution of (a);
(c) optionally adding at least one additional component selected from the group consisting of magnesium ions, calcium ions, hydrotrope, foam stabilizing agents, buffering agents, dyes, preservatives, fragrances, fillers, chelating agents, solubilizers, anti-irritant, soil release polymers, dispersants, thickeners, bactericides, antifungal agents, brighteners, enzymes, abrasives, and anti-corrosive aids to the solution of (b); and
(d) adding at least one fatty amine derivative selected from the group consisting of 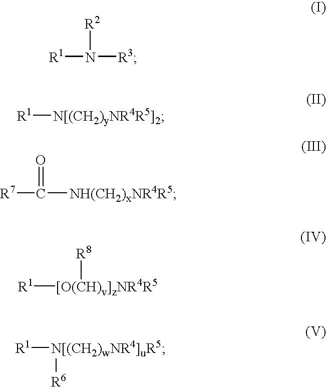
and mixtures thereof;
wherein R¹ is a C₆-C₂₂, linear or branched, saturated or unsaturated alkyl; R², R³, R⁴, R⁵, and R⁶are each either hydrogen, methyl, hydroxethyl, hydroxypropyl, or an alkyl; or R² and R³, or R⁴ and R⁵ form a heterocyclic ring of up to 6 members with the nitrogen; or R² and R³, or R⁴ and R⁵ together form the group —CH₂CH₂OCH₂CH₂—; R⁷ is a C₅-C₂₁, linear or branched, saturated or unsaturated alkyl; R⁸ is hydrogen or methyl; w, x, and y are each an integer from 2 to 6; z is an integer from 1 to 30; u is an integer greater than or equal to 1; and v is an integer greater than or equal to 2;
   to the solution of (c).

In a still further aspect, the present invention relates to a method of removing soils from hard surfaces comprising:
(a) applying to the hard surfaces a cleaning effective amount of a light duty liquid detergent composition which comprises
   (i) from about 5% to about 50% of an anionic base surfactant formulation, wherein the anionic base surfactant formulation comprises an alkylbenzene sulfonate having a C₆-C₂₂ alkyl group; and
   (ii) at least one fatty amine derivative selected from the group consisting of: 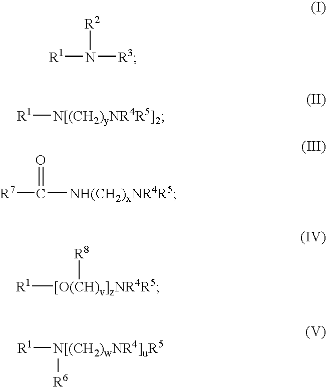
   and mixtures thereof;
   wherein R¹ is a C₆-C₂₂, linear or branched, saturated or unsaturated alkyl; R², R³, R⁴, R⁵, and R⁶ are each either hydrogen, methyl, hydroxethyl, hydroxypropyl, or an alkyl; or R² and R³, or R⁴ and R⁵ form a heterocyclic ring of up to 6 members with the nitrogen; or R² and R³, or R⁴ and R⁵ together form the group —CH₂CH₂OCH₂CH2—; R⁷ is a C₅-C₂₁, linear or branched, saturated or unsaturated alkyl; R⁸ is hydrogen or methyl; w, x, and y are each an integer from 2 to 6; z is an integer from 1 to 30; u is an integer greater than or equal to 1; and v is an integer greater than or equal to 2;
(b) permitting the light duty liquid detergent composition to loosen the soils; and
(c) rinsing the hard surface to remove the loosened soils and any residual amounts of the light duty liquid detergent composition.

The present invention still further relates to a method of washing soiled dishes or other kitchen items wherein an effective amount of the LDL composition described above is absorbed onto a cloth, sponge or similar cleaning tool; the cloth, sponge or similar cleaning tool is contacted with the surface of each soiled item; and each soiled item is rinsed in water. By “effective amount” is meant an amount sufficient to remove enough soil from the surface of the item for the user to determine the item has been adequately cleaned, as based on the habits and practices of the user.

The present invention additionally relates to a method of washing soiled items wherein an effective amount for cleaning of the LDL composition of the present invention is diluted in water to form a diluted solution and each of the soiled items are either immersed in the diluted solution and cleaned by contacting the surface of each of the soiled items with a cloth, sponge or similar cleaning tool; or a method by which a cleaning effective amount of the LDL composition of the present invention is diluted in water to form a diluted solution and a cloth sponge or similar cleaning tool is first immersed in the diluted solution and then the cloth sponge or similar cleaning tool is contacted with the surface of each of the soiled items. By “effective amount” is meant an amount sufficient to remove enough soil from the surface of the item for the user to determine the item has been adequately cleaned, as based on the habits and practices of the user.

Additional objects, advantages and novel features will be apparent to those skilled in the art upon examination of the description that follows.

All parts, percentages and ratios used herein are expressed as percent weight unless otherwise specified.

### DETAILED DESCRIPTION OF THE INVENTION

The present invention utilizes an anionic base surfactant formulation comprising at least one alkylbenzene sulfonate having a C₆-C₂₂ alkyl group. Other anionic surfactants, for example, alfa olefin sulfonates (AOS), paraffin sulfonates (PS), secondary alkane sulfonates (SAS), fatty alcohol sulfate (FAS), sulfonated fatty acids or their esters, or mixtures thereof, may also be utilized as part of the anionic base surfactant formulation of the present invention to further enhance the cleaning or other properties of the LDL. However, the addition of ether sulfates may have an antagonistic effect on the degreasing ability of the alkylbenzene sulfonate and, preferably, the present LDL composition is substantially free of ether sulfate.

Preferably, the anionic surfactant base formulation is present in an amount equal to about 5% to about 50% and more preferably, about 7% to about 30%. The alkylbenzene sulfonate may be either linear or branched and can be in the form of a sodium, magnesium, isopropylamine, triethanolamine, or calcium salt. In one preferred embodiment of the present invention, the alkylbenzene sulfonate is linear dodecylbenzene sulfonate in either magnesium or sodium form.

Secondary surfactants, either anionic or nonionic, may also be added to the LDL composition of the present invention. These secondary surfactants are not part of the base surfactant formulation and are added for a variety of other enhancing reasons including improved mildness to the skin, foam boosting, foam stabilization, and viscosity modification. For example, alkylbenzene sulfonates have a less desirable foaming profile when used with hard water and are also known to remove fat from the skin, leaving it dry with a tendency to crack. Typically, secondary surfactants would be added to the LDL in order to reduce the de-fatting effect and to provide foam boosting in hard water. Examples of suitable secondary surfactants include betaines, alkanolamides, amine oxides, alkylpolyglucosides, fatty acid glucamide, and fatty alkanol amides. However, amine oxides may have an antagonistic effect on the degreasing ability of the alkylbenzene sulfonate and, preferably, the present LDL composition is substantially free of amine oxide.

The present invention further comprises at least one fatty amine derivative selected from the group consisting of: 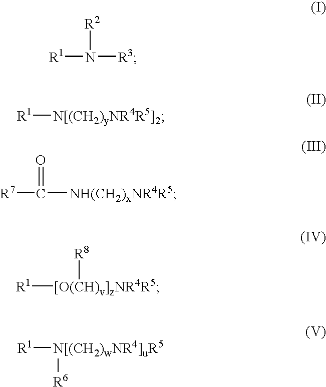
and mixtures thereof;
wherein R¹ is a C₆-C₂₂, linear or branched, saturated or unsaturated alkyl; R², R³, R⁴, R⁵, and R⁶ are each either hydrogen, methyl, hydroxethyl, hydroxypropyl, or an alkyl; or R² and R³, or R⁴ and R⁵ form a heterocyclic ring of up to 6 members with the nitrogen; or R² and R³, or R⁴ and R5 together form the group —CH₂CH₂OCH₂CH₂—; R⁷ is a C₅-C₂₁, linear or branched, saturated or unsaturated alkyl; R⁸ is hydrogen or methyl; w, x, and y are each an integer from 2 to 6; z is an integer from 1 to 30; u is an integer greater than or equal to 1; and v is an integer greater than or equal to 2.

The addition of one or more of the fatty amine derivatives described herein has surprisingly been found to synergistically boost the effectiveness of the alkylbenzene sulfonate to remove greasy or baked on soils. Preferably, the fatty amine derivative(s) is or are present in the LDL composition in an amount equal to about 0.1% to about 10%, more preferably in an amount equal to about 0.1% and about 5%, and most preferably in an amount equal to about 0.1% to about 2%.

If either ether sulfate or amine oxide or both are added to a LDL composition in accordance with the present invention, the amount of fatty amine derivative may be increased to counteract any antagonistic effect these surfactants may have on the ability of the alkylbenzene sulfonate to remove baked-on soil in order to achieve a cleaning performance equal to the LDL composition prior to the addition of ether sulfate or amine oxide or both.

The benefits of including an inorganic or organic salt or oxide of a multivalent cation, particularly magnesium and calcium ions, in LDL compositions is well known in the art. However, it is equally well known that the total amount of magnesium or calcium ions used in such compositions should be limited as these ions can often cause formulation difficulties. For example, typical magnesium ion content in a commercial LDL product varies from 0.04-0.4%. In addition to providing enhanced cleaning, the addition of the fatty amine derivatives with the anionic surfactant base formulation as described herein unexpectedly allows for effective cleaning without the inclusion of such ions. However, if desirable, these ions may still be included in the LDL composition of the present invention to further enhance the cleaning properties with the added benefit that there can be a reduction in the amount of the ions utilized in the LDL composition without any corresponding loss in cleaning effectiveness when compared to currently available LDL compositions. If such ions are added, preferably magnesium ions are utilized. In one preferred embodiment of the present invention, magnesium ions are added at levels of about 0.04% to about 0.25%. Examples of suitable sources of magnesium or calcium ions include salts such as chlorides, sulfates, acetates, sulfides, hydroxides or counter ions of surfactants such as ether sulfates, alkylbenzene sulfates, alkanolamides or combinations thereof.

Hydrotroping and coupling agents may optionally be included in the composition of the present invention to increase the solubility of the surfactants contained therein. Examples of suitable hydrotroping and coupling agents for use with the present invention include sodium xylene sulfonate, sodium cumene sulfonate, sodium toluene sulfonate, ethanol, isopropanol, propylene glycol, polyethylene glycol or mixtures thereof.

Buffering and neutralization agents may also be optionally added to the described composition to neutralize the alkylbenzene sulfonic acids and to adjust the formulation pH to optimize cleaning performance or to adjust the pH to a range considered milder to human skin. Examples of suitable buffering and neutralization agents for use in the present invention include urea, ammonia, sodium hydroxide, potassium hydroxide, citric acid, sulfuric acid, hydrochloric acid, alkanolamines, and ethanolamine. It is preferred for the pH of the present invention to be about 5 to about 12. More preferably, the pH of the present invention is about 7.5 to about 9.5.

In addition to the above described components, the present invention may optionally and preferably does contain one or more adjunct ingredients that serve to improve overall product performance and appearance. These include dyes, preservatives, fragrances, chelating agents, solubilizers, soil release polymers, anti-irritants, dispersants, thickeners, bactericides, antifungal agents, brighteners, enzymes, abrasives, and anti-corrosive aids. Any conventional adjunct ingredients known in the art are suitable for use herein. Examples of suitable preservatives include formaldehyde, glutaraldehyde, ethanol, benzoic acid, kathon, dowicil, bronopol, and hydroxybenzoic acid. Alcohol ethoxylates and fatty acid ethoxylates may also be added as adjuncts in order to provide additional cleaning performance.

When producing the LDL composition of the present invention, the improved cleaning performance is demonstrated only when the components are added in particular sequence. More specifically, the fatty amine derivative cannot be added as part of the neutralization package (i.e., with the neutralization agent). In one preferred method for producing the present invention, at least one neutralization agent is first added to water to form a solution. An alkylbenzene sulfonic acid having a C₆-C₂₂ alkyl group is added to the solution. If either ethoxylated ether sulfate or ethoxylated amides are utilized, these components must only be added when the solution is at approximately pH 6 or greater, as the ethoxylated ether sulfate will immediately hydrolyze at lower pH values. Buffering agents may need to be added prior to these components in order to adjust the pH to an appropriate value. Optional additional components, such as magnesium or calcium ions, hydrotropes, foam stabilizing agents, or buffering agents are added next. Any adjuncts being utilized, such those described above, are also added at this time. Then, one or more fatty amine derivatives are added. Finally, minor adjustments are made for viscosity and pH.

The present invention maintains its improved cleaning abilities when utilized in a variety of consumer washing methods. These methods include, for example, the following typical consumer practices:
(1) placing the LDL directly on the item to be washed or on the washing tool (sponge, brush, rag, etc), and washing the item with the washing tool;
(2) filling a tub, sink or pot with water and adding the LDL, submerging the item or items to be washed in the tub, sink or pot and then washing with a washing tool;
(3) adding LDL to a container, such as a basin or bowl, and filling the bowl with water; washing the item using the solution contained in the container.

The following examples illustrate the light duty liquid compositions of the described invention. These examples are illustrative and do not limit the scope of the invention. In all examples, ceramic tiles were soiled with common kitchen type soils such as lard, oil, flour, and milk and baked. The percent of soil removal was determined through spectrophotometer readings both before and after a mechanical scrub test was performed.

### EXAMPLE 1

The following light duty liquid compositions were prepared:

| | A | B | C | D | E |
|---|---|---|---|---|---|
| Water | 70 | 70 | 70 | 70 | 70 |
| Neutralization agent (NaOH) | 2 | 2 | 2 | 2 | 2 |
| Dodecylbenzene sulfonic acid | 20 | 20 | 20 | 20 | 20 |
| Sodium Laureth (2) Sulfate | 2.8 | 2.8 | 2.8 | 2.8 | 2.8 |
| Cocoamide DEA | 2 | 2 | 2 | 2 | 2 |
| Fatty Amine Derivative | | | | | |
| Ethoxylated (2) tallowalkylamine | | | 1 | | |
| Ethoxylated (5) tallowalkylamine | | | | 1 | |
| Ethoxylated (15) tallowalkylamine | | | | | 1 |
| Total (perfume, buffers, dye, | | | (to 100%) | | |
| ethanol, sodium xylene sulfonate) | | | | | |
| pH (at 10% aqueous solution) | 8 | 10 | 10 | 10 | 9.5 |
| Actual values (Soil Removal %) | 6 | 23 | 47 | 4 | 15 |

Approximately 2 weight % of a neutralizing agent, e.g., sodium hydroxide, was added to water. Dodecylbenzene sulfonic acid was slowly added until completely in solution. The other ingredients shown above were added in the order listed. Adjustments to the viscosity were made by using sodium xylene sulfonate in the above formulations until the final viscosity was between 300-400 cps. The pH was checked and adjusted where required.

As shown in Example 1, the capacity of the base formulation A to remove baked kitchen grease is very limited between ph 6-9, but increases by 20% when the formulation pH is 10 and above. No further increase is seen at higher pH values. The addition of 1% ethoxylated (2) tallowalkylamine in formula C in accordance with the present invention resulted in a 40% increase. Further increase in ethylene oxide content of the fatty amine derivative did not show the same boost in removal of baked on kitchen soil.

### EXAMPLE 2

The following light duty liquid compositions were prepared:

| | F | G | H | I | J | K | L |
|---|---|---|---|---|---|---|---|
| Water | 70 | 70 | 70 | 70 | 70 | 70 | 99 |
| Neutralization agent (NaOH) | 2 | 2 | 2 | 2 | 2 | 2 | — |
| Dodecylbenzene sulfonic acid | 20 | 20 | 20 | 20 | 20 | 20 | — |
| Sodium Ether(3) C12- | — | — | 0.9 | — | — | 0.9 | — |
| 14Alkyl Sulfate | | | | | | | |
| Magnesium ion (as | 0.3 | 0.15 | 0.15 | 0.3 | 0.15 | 0.15 | — |
| MgCl₂*6H2O) | | | | | | | |
| Fatty Amine Derivative | | | | | | | |
| Decylamidopropyl | — | — | — | 1 | 1 | 1 | 1 |
| dimethylamine | | | | | | | |
| Total (perfume, buffers, dye, | | | | (to 100%) | | | |
| ethanol, sodium xylene | | | | | | | |
| sulfonate) | | | | | | | |
| pH (at 10% aqueous solution) | 8.3 | 8.6 | 8.3 | 8.4 | 8.6 | 8.7 | |
| Actual values | 73 | 56 | 24 | 84 | 79 | 78 | 1 |
| (Soil Removal %) | | | | | | | |

Approximately 2 weight % of a neutralizing agent, e.g. sodium hydroxide was added to water. Dodecylbenzene sulfonic acid was added until completely solublized. The remaining ingredients were then added in the order listed above. Viscosity was adjusted by using sodium xylene sulfonate until a final viscosity between 300-400 cps was achieved. The pH was checked and, if needed, was adjusted to approximately 8.5.

As can be seen in example 2, the addition of magnesium ions to a dodecybenzene sulfonate formula results a dramatic increase in cleaning. At a 0.3% level of magnesium ions with DDBSA the removal of soil is significant, but drops by 20% when the magnesium is decreased to 0.15%. A further decrease is seen when a sodium laureth (2) sulfate is added to the formulation. However, the addition of 1% fatty amine derivative to each formulation as described in the present invention results in a statistically significant increase in soil removal, even with 0.3% Magnesium ions. As can be seen in formula L above, no cleaning occurs with just the fatty amine derivative alone.

### EXAMPLE 3

The following light duty liquid compositions are made:

| | M | N | O |
|---|---|---|---|
| Water | 70 | 70 | 70 |
| Neutralization agent (NaOH) | 2 | 2 | 2 |
| Dodecylbenzene sulfonic acid | 20 | 20 | 20 |
| Sodium Laureth (3) Sulfate | 1.2 | 1.2 | 1.2 |
| Cocoamide DEA | 1.5 | 1.5 | 1.5 |
| Magensium ion (as MgCl₂*6H2O) | 0.06 | 0.06 | 0.12 |
| Fatty Amine Derivative | | 1 | 1 |
| Ethoxylate (3) N-tallow 1,3-diaminopropane | | | |
| Total (perfume, buffers, dye ethanol, water) | | (to 100%) | |
| pH (at 10% aqueous solution) | 8.4 | 8.4 | 8.8 |
| Actual values (Soil Removal %) | 12 | 34 | 49 |

Approximately 2 weight % of sodium hydroxide was added to water. Dodecylbenzene sulfonic acid was added slowly until completely in solution. The other ingredients set forth above were added in the order of listed. Viscosity was adjusted by using sodium xylene sulfonate in the above formulations until final viscosity between 300-400cps was achieved. The pH was checked and, if needed, adjusted to approximately 8.5.

The reduction of Magnesium to 0.06% and an increase in sodium laureth (3) sulfate shows a further lowering of the cleaning performance as compared to formula H in example 2. The addition of the fatty amine derivative to Formula M in accordance with the present invention results in a significant increase in the removal of the baked-on kitchen soil.

### EXAMPLE 4

Formulation P was prepared using the same components and in the same amounts as for formulation O in example 3, except that the fatty amine derivative was added as part of the neutralization package.

| | P |
|---|---|
| Water | 70 |
| Fatty Amine Derivative | 1 |
| Ethoxylate (3) N-tallow 1,3-diaminopropane | |
| Dodecylbenzene sulfonic acid | 20 |
| Sodium Laureth (3) Sulfate | 1.2 |
| Cocoamide DEA | 1.5 |
| Magensium ion (as MgCl₂*6H2O) | 0.12 |
| Total (perfume, buffers, dye ethanol, water) | (to 100%) |
| pH (at 10% aqueous solution) | 8.6 |
| Actual values (Soil Removal %) | 13 |

As shown above, there is a significant drop in cleaning when formula P is compared with formula O in example 3.

### EXAMPLE 5

Fatty amine derivatives were added to a commercial LDL formulation based on the following ingredients: sodium laureth sulfate, sodium dodecylbenzene sulfonate, amine oxide, sulfonated methylesters, plus other minor ingredients. The formula has a Magnesium ion content of about 0.36%.

| | Q | R | S | T | U | V | X |
|---|---|---|---|---|---|---|---|
| Fatty Amine Derivative | | | | | | | |
| Propoxylated (2) tallowamine | | | 1 | | | | |
| Ethoxylated (2) soyaalkylamine | | | | 0.5 | | | |
| Ethoxylate (3) N-tallow 1,3- | | | | | 0.5 | | |
| diaminopropane | | | | | | | |
| N-Coco-1,3-diaminopropane | | | | | | 0.5 | |
| N-(3-aminopropyl)-N-tallowalkyl | | | | | | | 0.5 |
| trimethylene diamine | | | | | | | |
| pH (at 10% aqueous solution) | 7.5 | 8 | 8 | 7.8 | 8 | 8.4 | 8.2 |
| Actual values (Soil Removal %) | 13 | 16 | 44 | 31 | 53 | 55 | 59 |

Formulations S through X, all show a significantly increase in the removed of the baked on kitchen soil with the addition of the various fatty amine derivatives as described herein.

What is claimed is:

1. A light duty liquid detergent composition comprising:
(a) from about 5% to about 50%, by weight, of an anionic base surfactant formulation, wherein the anionic base surfactant formulation comprises an alkylbenzene sulfonate having a C₆-C₂₂ alkyl group; and
(b) at least one fatty amine derivative selected from the group consisting of: 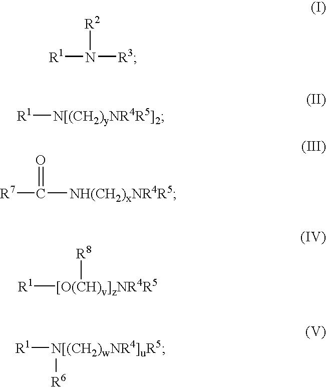
and mixtures thereof;
wherein R¹ is a C₆-C₂₂, linear or branched, saturated or unsaturated alkyl; R², R³, R⁴, R⁵, and R⁶ are each either hydrogen, methyl, hydroxethyl, hydroxypropyl, or an alkyl; or R² and R³, or R⁴ and R⁵ form a heterocyclic ring of up to 6 members with the nitrogen; or R² and R³, or R⁴ and R⁵ together form the group —CH₂CH₂OCH₂CH2—; R⁷ is a C₅-C₂₁, linear or branched, saturated or unsaturated alkyl; R⁸ is hydrogen or methyl; w, x, and y are each an integer from 2 to 6; z is an integer from 1 to 30; u is an integer greater than or equal to 1; and v is an integer greater than or equal to 2.

2. The composition of claim 1 further comprising at least one secondary surfactant selected from the group consisting of betaines, alkanolamides, amine oxides, alkylpolyglucosides, fatty acid glucamide, fatty alkanol amides and mixtures thereof.

3. The composition of claim 1 wherein the fatty amine derivative is present in an amount equal to about 0.1% to about 10% by weight.

4. The composition of claim 3 wherein the fatty amine derivative is present in an amount equal to about 0. 1% to about 5% by weight.

5. The composition of claim 4 wherein the fatty amine derivative is present in an amount equal to about 0.1% to about 2% by weight.

6. The composition of claim 1 wherein the alkylbenzene sulfonate is dodecylbenzene sulfonate.

7. The composition of claim 6 wherein the dodecylbenzene sulfonate is present in an amount equal to about 7% to about 30%, by weight, of the composition.

8. The composition of claim 7 wherein the dodecylbenzene sulfonate is present in an amount equal to about 15% to about 30%, by weight, of the composition.

9. The composition of claim 1 wherein the anionic surfactant base formulation further comprises at least one additional anionic surfactant selected from the group consisting of olefin sulfonates, paraffin sulfonates, secondary alkane sulfonates, fatty alcohol sulfates and mixtures thereof.

10. The composition of claim 1 having a pH between 5 and 11.

11. The composition of claim 1 having a pH between 7.5 and 9.5.

12. The composition of claim 1 further comprising magnesium or calcium ions.

13. The composition of claim 12 comprising less than about 0.25% of magnesium ions.

14. The composition of claim 1 further comprising at least one hydrotrope.

15. The composition of claim 1 further comprising at least one foam stabilizing agent.

16. The composition of claim 1 further comprising at least one buffering agent.

17. The composition of claim 1 further comprising at least one neutralization agent.

18. The composition of claim 1 further comprising at least one adjunct selected from the group consisting of dyes, preservatives, fragrances, fillers, chelating agents, solubilizers, anti-irritants, soil release polymers, dispersants, thickeners, bactericides, antifungal agents, brighteners, enzymes, abrasives, and anti-corrosive aids.

19. The composition of claim 1 wherein the anionic surfactant base formulation is substantially free of ether sulfate.

20. light duty liquid detergent composition comprising:
(a) less than about 15%, by weight, of dodecylbenzene sulfonic acid; and
(b) at least one fatty amine derivative selected from the group consisting of: 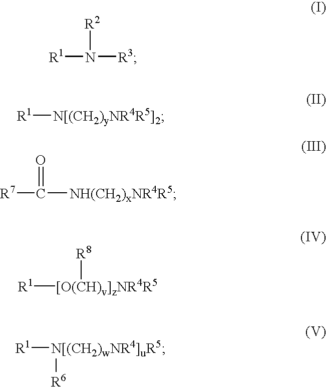
and mixtures thereof;
wherein R¹ is a C₆-C₂₂, linear or branched, saturated or unsaturated alkyl; R², R³, R⁴, R⁵, and R⁶are each either hydrogen, methyl, hydroxethyl, hydroxypropyl, or an alkyl; or R² and R³, or R⁴ and R⁵ form a heterocyclic ring of up to 6 members with the nitrogen; or R² and R³, or R⁴ and R⁵ together form the group —CH₂CH₂OCH₂CH₂—; R⁷ is a C₅-C₂₁, linear or branched, saturated or unsaturated alkyl; R⁸ is hydrogen or methyl; w, x, and y are each an integer from 2 to 6; z is an integer from 1 to 30; u is an integer greater than or equal to 1; and v is an integer greater than or equal to 2.

21. The composition of claim 20 wherein the fatty amine derivative is present in an amount equal to about 0.1% to about 10% by weight.

22. The composition of claim 21 wherein the fatty amine derivative is present in an amount equal to about 0.1% to about 5% by weight.

23. The composition of claim 22 wherein the fatty amine derivative is present in an amount equal to about 0.1% to about 2% by weight.

24. The composition of claim 20 wherein the dodecylbenzene sulfonic is present in an amount equal to about 7% to about 15%, by weight, of the composition.

25. The composition of claim 20 further comprising less than about 0.25% of magnesium ions.

26. The composition of claim 20 wherein the anionic surfactant base formulation is substantially free of ether sulfate.

27. A method for removing soils from hard surfaces comprising:
(a) applying to the hard surface an effective amount of a light duty liquid detergent composition according to claim 1;
(b) permitting the light duty liquid detergent composition to loosen the soils; and
(c) rinsing the hard surface to remove the loosened soils and any residual amounts of the light duty liquid detergent composition.

28. A method of washing a soiled item or items wherein
(a) a cleaning effective amount of the composition according to claim 1 is absorbed onto a cloth, sponge or similar cleaning tool; and
(b) the cloth, sponge or similar cleaning tool is contacted with the surface of the soiled item or items.

29. A method of washing soiled items according to claim 28 further comprising step (c) wherein the soiled item or items are rinsed with water.

30. A method of washing a soiled item or items wherein a cleaning effective amount of the composition according to claim 1 is diluted in water to form a diluted solution and the soiled item or items are immersed in the diluted solution and cleaned by contacting the surface of each of the soiled items with a cloth, sponge or similar cleaning tool.

31. A method of washing a soiled item or items wherein a cleaning effective amount of the composition according to claim 1 is diluted in water to form a diluted solution and a cloth sponge or similar cleaning tool is first immersed in the diluted solution and then the cloth sponge or similar cleaning tool is contacted with the surface of the soiled item or items.

32. A method of making a light duty liquid detergent composition comprising the steps of:
(a) adding at least one neutralization agent to water to form a solution;
(b) adding an alkylbenzene sulfonic acid having a C₆-C₂₂ alkyl group to the solution of (a);
(c) optionally adding one or more additional components selected from the group consisting of magnesium ions, calcium ions, hydrotropes, secondary surfactants, foam stabilizing agents, buffering agents, dyes, preservatives, fragrances, fillers, chelating agents, solubilizers, anti-irritant, soil release polymers, dispersants, thickeners, bactericides, antifungal agents, brighteners, enzymes, abrasives, and anti-corrosive aids to the solution of (b); and
(d) adding at least one fatty amine derivative selected from the group consisting of 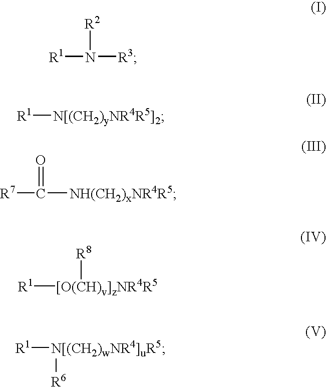
and mixtures thereof;
wherein R¹ is a C₆-C₂₂, linear or branched, saturated or unsaturated alkyl; R², R³, R⁴, R⁵, and R⁶ are each either hydrogen, methyl, hydroxethyl, hydroxypropyl, or an alkyl; or R² and R³, or R⁴ and R⁵ form a heterocyclic ring of up to 6 members with the nitrogen; or R² and R³, or R⁴ and R⁵ together form the group —CH₂CH₂OCH₂CH₂—; R⁷ is a C₅-C₂₁, linear or branched, saturated or unsaturated alkyl; R⁸ is hydrogen or methyl; w, x, and y are each an integer from 2 to 6; z is an integer from 1 to 30; u is an integer greater than or equal to 1; and v is an integer greater than or equal to 2;
to the solution of (c).

33. A method according to claim 32 further comprising adding one or more viscosity modifiers or buffering agents to adjust the pH of the composition.

34. A light duty liquid detergent composition produced by the method according to claim 32.
